(19) United States
(12) Patent Application Publication
(10) Pub. No.: US 2024/0416277 A1
(43) Pub. Date: Dec. 19, 2024

(54) SYSTEM AND A METHOD FOR REDUCING NITROGEN DIOXIDE (NO2) CONTENT IN FLUE GAS

(71) Applicant: Pentair, Inc., Minneapolis, MN (US)

(72) Inventors: Soren JENSEN, Fredericia (DK); Niels LARSEN, Odense C (DK); Kristoffer MOOS, Middelfart (DK)

(21) Appl. No.: 18/704,323

(22) PCT Filed: Dec. 27, 2022
(86) PCT No.: PCT/US2022/082438

§ 371 Date: Apr. 24, 2024

Related U.S. Application Data
(60) Provisional application No. 63/266,134, filed on Dec. 29, 2021.

(51) Int. Cl. B01D 53/56

(52) U.S. Cl. CPC B01D 53/56; B01D 2251/304; B01D 2251/306; B01D 2257/404; B01D 2258/0283

(57) ABSTRACT

A system and a method for reducing nitrogen dioxide (NO₂) content of a flue gas are provided. The system comprises a wash column that is designed to receive a flue gas containing nitrogen dioxide and treat the flue gas with a first water stream. The first water stream contains a thiosulfate salt reactant. The thiosulfate salt reactant reacts with the nitrogen dioxide to remove the nitrogen dioxide from the flue gas. The wash column can provide a treated flue gas that is substantially free of nitrogen dioxide, or a treated flue gas that contains less nitrogen dioxide than untreated flue gas.

### CROSS-REFERENCE TO RELATED APPLICATIONS

This application claims priority to U.S. Provisional Patent Application Ser. No. 63/266,134, filed on Dec. 29, 2021, entitled “SYSTEM AND A METHOD FOR REDUCING NITROGEN DIOXIDE (NO₂) CONTENT IN FLUE GAS,” currently pending, the entire disclosure of which is incorporated herein by reference.

### FIELD OF INVENTION

The present system and method relate to reducing nitrogen dioxide (NO₂) content in a flue gas stream. More particularly, the present system and method relate to reducing nitrogen dioxide (NO₂) content in a flue gas stream using a thiosulfate reactant or reagent.

### BACKGROUND

In general, flue gases are generated in industrial plants during combustion processes. The combustion that generates the flue gas may occur in a turbine, an engine, a boiler, or any other environment where fuel is burned. The flue gas may contain atmospheric components, combustion products (e.g., carbon monoxide (CO) and carbon dioxide (CO₂)), undesirable products (e.g., nitrogen dioxide (NO₂)), and/or other contaminants. Any of these substances may be removed from the flue gas before the flue gas is vented, captured, or otherwise processed.

CO₂ can be removed from the flue gas by an absorption process. However, any NO₂ in the flue gas can degrade the solvent used for CO₂ removal, particularly if an amine-based solvent is used. If the flue gas contains NO₂, the NO₂ will often irreversibly react with the solvent. Eventually, the irreversible reaction may fully deactivate the solvent unless a new solvent is added to the absorption process. Unfortunately, adding additional solvent to the absorption process increases the plant's operating cost. Further, some solvent degradation reaction paths produce carcinogenic compounds (e.g., nitrosamines). Finally, any unreacted NO₂ carries over to downstream processes in a CO₂ removal unit, making further cleaning of the CO₂ necessary.

One solution for removing NO₂ from the flue gas stream is Selective Catalytic Reduction (“SCR”) technology. To remove the NO₂, the SCR technology requires that the flue gas be passed over a catalyst at a high temperature (approximately 150-400° C.) and dosed with a reducing agent (such as ammonia or urea). Unfortunately, this solution presents substantial obstacles for plant operators. First, the SCR technology increases plant energy consumption and plant operating costs because it requires the use of high temperatures. Second, the SCR technology is sensitive to the presence of impurities, as the reducing agents used in the process may react with any acidic compound present, thereby diminishing the amount of reducing agent available to react with the NO₂. Finally, the SCR technology typically requires the use of additional equipment in the plant, which further increases flue gas processing costs.

### SUMMARY

A system for reducing nitrogen dioxide (NO₂) content in flue gas is provided. The system comprises a wash column designed to receive the flue gas containing nitrogen dioxide (NO₂) content in a wash column and treat the flue gas containing nitrogen dioxide (NO₂) content with a water stream. The water stream includes a thiosulfate salt reactant for reducing the content of nitrogen dioxide (NO₂) in the flue gas.

An apparatus for reducing the nitrogen dioxide content of a flue gas is also provided. The apparatus comprises a wash column in fluid communication with a water stream. The wash column includes an inlet in which the flue gas is provided to the wash column from a source and a dosing mechanism designed to provide a thiosulfate salt reactant to the water stream. The thiosulfate salt reactant reacts with the flue gas to remove the nitrogen dioxide therefrom.

A method of reducing the nitrogen dioxide content of a flue gas is further provided. The method comprises the steps of providing the flue gas to a wash column, dosing a water stream with a thiosulfate salt reactant, and contacting the flue gas with the water stream.

The thiosulfate salt reactant may be provided in the form of at least one of a sodium thiosulfate (Na₂S₂O₃) salt reactant, a potassium thiosulfate (K₂S₂O₃) salt reactant, a magnesium thiosulfate (MgS₂O₃) salt reactant, a calcium thiosulfate (CaS₂O₃) salt reactant, an ammonium thiosulfate ((NH₄)₂S₂O₃) salt reactant, and mixtures thereof.

In some embodiments, a dosing mechanism in communication with a controller is provided. The dosing mechanism is designed to provide the thiosulfate salt reactant to a water stream, and the controller is designed to control an amount of the thiosulfate salt reactant provided to the water stream by the dosing mechanism.

In some embodiments, a dosing mechanism is in communication with or coupled to a water stream recycle conduit.

In some embodiments, the flue gas containing nitrogen dioxide is received by or enters the wash column via a bottom portion of the wash column.

In some embodiments, the water stream enters or is received by a top portion of the wash column.

In some embodiments, the water stream is circulated from the bottom portion to the top portion of the wash column via a circulation pump.

In some embodiments, the water stream is provided to the wash column via a water stream recycle conduit.

In some embodiments, the flue gas exiting the wash column is substantially free of nitrogen dioxide (NO₂) upon exiting from the wash column.

In some embodiments, the flue gas exiting the wash column contains less nitrogen dioxide (NO₂) than the flue gas entering the wash column.

In some embodiments, a flue gas discharge line is coupled to the wash column, and the flue gas discharge line is in fluid communication with an analyzer adapted to measure at least one parameter of the flue gas. In some such embodiments, a first parameter of the at least one parameter is a nitrogen dioxide concentration of the flue gas. The analyzer measures a value of the first parameter, and an amount of thiosulfate salt reactant provided to the water stream by the dosing mechanism is adjusted based on the value of the first parameter.

In some embodiments, a controller is adapted to change an amount of thiosulfate salt reactant provided to the water stream by a dosing mechanism based on a measurement of the at least one parameter of the flue gas by an analyzer.

In some embodiments, an amount of the thiosulfate salt reactant added to the water stream is at least partially based on an amount of unreacted nitrogen dioxide (NO₂) content in the flue gas exiting from a top portion of the wash column.

In some embodiments, a first water stream is in fluid communication with a heat exchanger designed to remove the heat absorbed by the first water stream from the flue gas.

In some embodiments, the water stream is introduced to a heat exchanger to lower the temperature of the water stream. The water stream is introduced to the heat exchanger before the water stream reenters the wash column.

In some embodiments, the flue gas is provided to the wash column at a first temperature, a first water stream is provided to the wash column at a second temperature, and the first temperature is greater than the second temperature.

In some embodiments, the flue gas containing the nitrogen dioxide (NO₂) is generated in a turbine, an engine, a boiler, or a plant where fuel is burned.

In some embodiments, the nitrogen dioxide (NO₂) content of the flue gas is reduced from about 0.01% (v/v) to a range of about 0.0005% to about 0.0001% (v/v).

In some embodiments, the nitrogen dioxide (NO₂) content of the flue gas is reduced from about 0 to about 2% (v/v) to a range of about 0.0005% to about 0.0001% (v/v).

In some embodiments, the nitrogen dioxide (NO₂) content of the flue gas is reduced by about 60% to about 100% after treatment in the system.

In some embodiments, the nitrogen dioxide (NO₂) content of the flue gas is reduced when the flue gas is at a temperature of about 25° C. to about 80° C.

In some embodiments, the amount of thiosulfate salt reactant provided to the water stream ranges from about 0.001 to about 10 moles per mole of the nitrogen dioxide (NO₂) in the flue gas.

In some embodiments, the flue gas exiting the wash column is contacted with a second water stream containing a thiosulfate salt reactant in an additional or secondary nitrogen dioxide (NO₂) reduction step.

In some embodiments, the wash column further includes a gas cooling section and a reaction section. The gas cooling section is positioned adjacent to a bottom section of the wash column and the reaction section is positioned adjacent to a top section of the wash column. In some such embodiments, a first water stream is provided to the reaction section, and a second water stream is provided to the gas cooling section.

In some embodiments, the method further includes a step of circulating the water stream through a water stream recycle conduit, wherein the water stream recycle conduit is in fluid communication with the wash column and a dosing mechanism.

In some embodiments, the method further includes a step of measuring a parameter of the flue gas via an analyzer.

In some embodiments, the method further includes steps of measuring a nitrogen dioxide concentration of the flue gas using an analyzer and adjusting an amount of thiosulfate salt reactant provided to the water stream when the nitrogen dioxide concentration of the flue gas is at or above a threshold value.

In some embodiments, the method further includes steps of cooling the flue gas to condense water therefrom and providing condensed water to a bleed member.

### DESCRIPTION OF THE DRAWINGS

FIG. 1 is a block diagram of an embodiment of a system designed to reduce nitrogen dioxide (NO₂) content of a flue gas stream;

FIG. 2 is a block diagram of another embodiment of a system designed to reduce nitrogen dioxide (NO₂) content of a flue gas stream;

FIG. 3 is a schematic representation of a method for reducing nitrogen dioxide (NO₂) content in a flue gas;

FIG. 4 is a schematic representation of another method for reducing nitrogen dioxide (NO₂) content in a flue gas; and

FIG. 5 is a schematic representation of yet another method for reducing nitrogen dioxide (NO₂) content in a flue gas.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited.

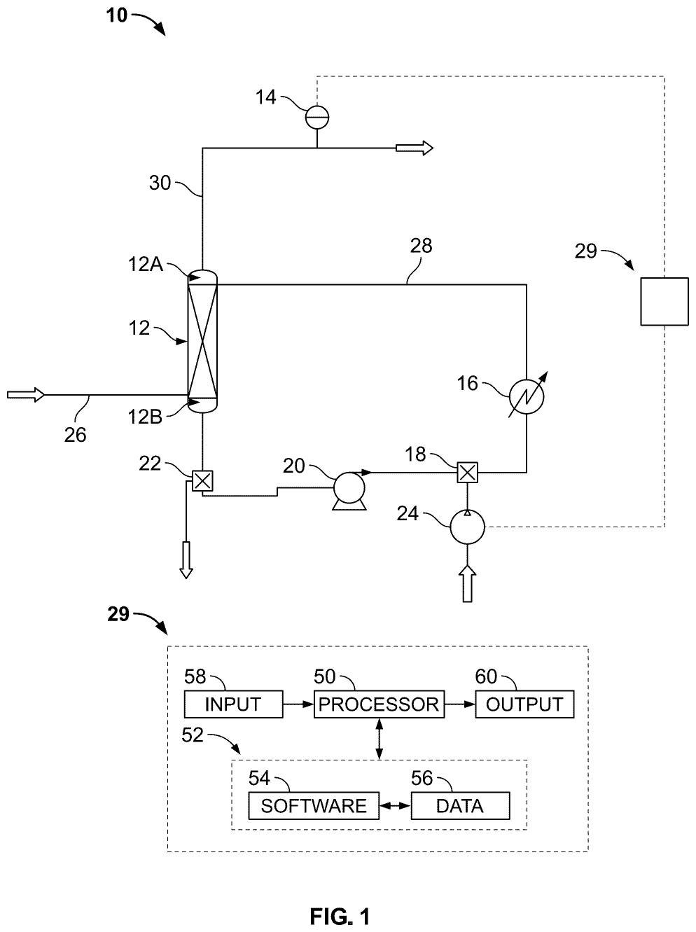

Referring now to FIG. 1, a system 10 to reduce the nitrogen dioxide (NO₂) content of a flue gas stream is illustrated. The system 10 may be provided in the form of a wash column 12, an analyzer 14, a heat exchanger 16, a mix point 18, a circulation pump 20, a discharge or drain point 22, a dosing mechanism 24, and a controller 29. As would be understood by one skilled in the art, the illustrated embodiment of the system 10 is provided as a reference only, and the system 10 may contain additional or fewer components for processing the flue gas.

The flue gas processed by the system 10 may be generated by a source (not illustrated). The source may be in fluid communication with the system 10 via a conduit 26. The source may be a component or location wherein a combustion reaction that produces the flue gas is carried out. For example, the source may be provided in the form of a turbine, an engine, a boiler, or another environment where a fuel (e.g., a hydrocarbon-based fuel) is burned.

The contents of the flue gas may depend on various factors, including, by way of example, the fuel combusted, the amount of oxygen provided to the combustion process, the composition of the atmosphere in which the combustion process is carried out, and the like. The flue gas provided to the system 10 may comprise NO₂ in an amount of about 0% (v/v) to about 2% (v/v). For example, the flue gas may comprise NO₂ in an amount of about 0% (v/v) to about 1% (v/v). For example, the flue gas may comprise NO₂ in an amount of no greater than about 2% (v/v), or no greater than about 1.9% (v/v), or no greater than about 1.8% (v/v), or no greater than about 1.7% (v/v), or no greater than about 1.6% (v/v), or no greater than about 1.5% (v/v), or no greater than about 1.4% (v/v), or no greater than about 1.3% (v/v), or no greater than about 1.2% (v/v), or no greater than about 1.1% (v/v), or no greater than about 1% (v/v), or no greater than about 0.9% (v/v), or no greater than about 0.8% (v/v), or no greater than about 0.7% (v/v), or no greater than about 0.6% (v/v), or no greater than about 0.5% (v/v), or no greater than about 0.4% (v/v), or no greater than about 0.3% (v/v), or no greater than about 0.2% (v/v), or no greater than about 0.1% (v/v), or no greater than about 0.05% (v/v), or no greater than about 0.01% (v/v), or no greater than about 0.01% (v/v), or no greater than about 0.001% (v/v), or no greater than about 0.0001% (v/v), or no greater than about 0% (v/v).

In some embodiments, the flue gas comprises:
about 2% (v/v) to about 30% (v/v) carbon dioxide (CO₂);
about 2% (v/v) to about 19% (v/v) oxygen (O₂);
about 60% (v/v) to about 80% (v/v) nitrogen (N₂);
about 0% (v/v) to about 25% (v/v) water (H₂O);
about 0% (v/v) to about 5% (v/v) carbon monoxide (CO);
about 0.01% (v/v) to about 2% (v/v) nitric oxide (NO);
about 0% (v/v) to about 2% (v/v) nitrogen dioxide (NO₂); and
about 0% (v/v) to about 2% (v/v) sulfur dioxide (SO₂).

For example, the flue gas may comprise:
about 5% (v/v) carbon dioxide (CO₂);
about 10% (v/v) oxygen (O₂);
about 70% (v/v) nitrogen (N₂);
about 10% (v/v) water (H₂O);
about 0.02% (v/v) carbon monoxide (CO);
about 0.01% (v/v) nitric oxide (NO);
about 0.01% (v/v) nitrogen dioxide (NO₂); and
about 0.01% (v/v) sulfur dioxide (SO₂).

The flue gas may enter, be received in, or otherwise provided to the wash column 12 for treatment. The wash column 12 may be provided in the form of a vessel with a top portion 12A and a bottom portion 12B, wherein the portions 12A, 12B are designed to receive gases and liquids provided thereto. Generally, the wash column 12 may be designed to bring a gas (i.e., the flue gas) into contact with a washing liquid (e.g., a water stream). In some embodiments of the wash column 12, the gas and the liquid are contacted in a counter-flow manner, wherein the gas flows through the vessel in a first direction and the liquid flows through the vessel in a second (e.g., opposite) direction. For example, in the wash column 12, the flue gas may enter the wash column 12 and flow in a first direction (e.g., upwardly) while the water stream may enter the wash column 12 and flow in a second direction (e.g., downwardly). The wash column 12 may also include components designed to help generate a high surface area for the washing liquid (e.g., a water stream), which may help facilitate contact between the gas and the washing liquid. For example, the wash column 12 may include packing materials or trays to help separate the bulk washing liquid into smaller droplets, thereby creating a high surface area for the washing liquid. As an additional example, the washing liquid may be sprayed into the wash column 12 via a dispensing apparatus (not illustrated) that generates droplets of the washing liquid, thereby increasing the surface area of the washing liquid.

Referring still to FIG. 1, the flue gas may enter or be received in the wash column 12 via the bottom portion 12B. The bottom portion 12B may include a flue gas inlet (not illustrated) designed to introduce the flue gas to the wash column 12. The washing liquid, provided here as a water stream, may enter or be received in the wash column 12 via the top portion 12A. The top portion 12A may include a washing liquid inlet (not illustrated) that is designed to introduce the water stream to the wash column 12. In some embodiments, the inlet for the water stream may be in fluid communication with a dispensing mechanism, for example, a spray mechanism that can separate the water stream into droplets and/or aerosolize the water stream to increase its surface area as the water stream is introduced to the wash column 12. In yet other embodiments, the water stream may be introduced to the wash column 12 in the bulk phase.

The flue gas and the water stream may flow through the wash column 12 in a counter-flow manner, wherein the flue gas travels through the wash column 12 in a first direction and the water stream travels through the wash column 12 in a second direction. For example, the flue gas may travel from the bottom portion 12B and towards the top portion 12A after being introduced to the wash column 12, and the water stream may travel from the top portion 12A and towards the bottom portion 12B after being introduced to the wash column 12.

In alternative embodiments, the flue gas and the water stream may enter, be received in, or otherwise provided to the wash column 12 in other locations than the bottom portion 12B and the top portion 12A, respectively.

The circulation pump 20 may feed or supply the water stream to the top portion 12A of the wash column 12. The circulation pump 20 may be provided in the form of any pump known in the art that can circulate water through a closed or a partially closed fluid circuit. The circulation pump 20 may be provided with water from a water source (not illustrated), and/or the circulation pump 20 may be provided with a recycled water stream that is obtained from the wash column 12 after the water stream exits the wash column 12.

In some embodiments, the circulation pump 20 may be positioned and located in a water stream recycle conduit 28. The water stream recycle conduit 28 may be in fluid communication with the top portion 12A and the bottom portion 12B of the wash column 12. After the water stream exits the wash column 12 through the bottom portion 12B, the water stream can be recirculated or recycled to the top portion 12A via the water stream recycle conduit 28. In some instances, a portion of the water stream may be recycled while another portion of the water stream may be discarded or otherwise drained (not shown).

In some embodiments, the water stream is provided at a high pressure to the wash column 12. In such embodiments, the circulation pump 20 may be utilized to pressurize the water stream.

Referring still to FIG. 1, the circulation pump 20 may also be in fluid communication with the mix point 18 provided in the conduit. A thiosulfate salt reactant may be introduced to the water stream at the mix point 18 via the dosing mechanism 24. Thus, the thiosulfate salt reactant may be mixed or combined with the water stream at the mix point 18. The location of the mix point 18 (and thus the dosing mechanism 24) is not particularly limited. By way of example, the mix point 18 may be provided after the circulation pump 20 in the water stream recycle conduit 28, before the circulation pump 20 in the water stream recycle conduit 28, at the water stream inlet provided in the top portion 12A of the wash column 12, and/or at the wash column 12 at a location other than the top portion 12A. Preferably, the thiosulfate salt reactant is provided to the water stream by the dosing mechanism 24 before the water stream enters or is otherwise provided to the wash column 12.

The dosing mechanism 24 may be provided in the form of any mechanism that is designed to deliver a metered amount of a reactant or a reagent to the mix point 18. For example, the dosing mechanism 24 may be provided in the form of an injector that is in communication with a source of the thiosulfate salt reactant. By way of non-limiting example, the dosing mechanism 24 may be provided in the form of a piston-plunger mechanism, a mechanical diaphragm, a hydraulic diaphragm, a flow control valve, a blend valve, a fixed orifice, a venture meter, a metering pump, a piston valve, and/or a micro-doser.

The dosing mechanism 24 may be utilized to provide any reactant or reagent to the water stream that may reduce the concentration of NO₂ in the flue gas. Preferably, a thiosulfate salt reactant is introduced to the water stream by the dosing mechanism 24. Preferably, the thiosulfate salt reactant is introduced to the water stream in the form of an aqueous solution, although the thiosulfate salt reactant may also be introduced to the water stream in the form of a solid. For example, the thiosulfate salt reactant may be provided in the form of tablets which are configured to dissolve in the water stream before the water stream enters the wash column 12.

The thiosulfate salt reactant may be provided in the form of a compound containing a thiosulfate (S₂O₃²⁻) functional group. For example, the thiosulfate salt reactant may comprise a metal that is ionically bonded to the thiosulfate functional group. As an additional example, the thiosulfate salt reactant may comprise at least one of a sodium thiosulfate (Na₂S₂O₃) salt reactant, a potassium thiosulfate (K₂S₂O₃) salt reactant, a magnesium thiosulfate (MgS₂O₃) salt reactant, a calcium thiosulfate (CaS₂O₃) salt reactant, an ammonium thiosulfate ((NH₄)₂S₂O₃) salt reactant, and/or mixtures thereof.

The thiosulfate salt reactant may be continuously provided to the water stream at a fixed flow or fixed dosing rate, continuously at a varying flow or dosing rate, or only as needed. Measurements of the NO₂ concentration of the flue gas taken upstream or downstream of the wash column 12 may be used to adjust the amount of thiosulfate salt reactant provided to the water stream by the dosing mechanism 24. For example, measurements of a treated flue gas that are taken downstream of the wash column 12 (e.g., measurements taken by the analyzer 14) may be used to adjust the amount of thiosulfate salt reactant provided to the water stream. As explained in more detail herein, measurements of the untreated flue gas or the treated flue gas may be carried out via an analyzer that can measure at least one parameter of the untreated or treated flue gas.

One or more components of the system 10 may be in communication with the controller 29, which is designed to control various aspects of the system. In one instance, the dosing mechanism 24 may be in communication with the controller 29. The controller 29 may be designed to change the amount of thiosulfate salt reactant the dosing mechanism 24 provides to the water stream in response to the measurement of at least one parameter of the untreated or treated flue gas by an analyzer (such as the analyzer 14). The operation and the components of the controller 29 will be described in further detail herein.

In embodiments where the amount of thiosulfate salt reactant provided to the water stream depends upon the NO₂ content of the untreated flue gas, the amount of thiosulfate salt reactant provided to the water stream may be about 0.001 moles to about 10 moles of thiosulfate salt reactant per 1 mole of NO₂ in the untreated flue gas. For example, about 0.33 moles of the thiosulfate salt reactant may react with about 1 mole of NO₂ in the untreated flue gas.

After the flue gas containing the NO₂ is treated with the water stream containing the thiosulfate salt reactant, the flue gas may be substantially free of NO₂ or may contain a reduced amount of NO₂. The treated flue gas may exit the wash column 12 via an outlet provided in the top portion 12A and enter a flue gas discharge line 30.

The heat exchanger 16 may be provided in the water stream recycle conduit 28. The heat exchanger 16 may be designed to reduce the temperature of the water stream. In some embodiments of the system 10, the untreated flue gas may be provided to the wash column at a first temperature, the water stream may be provided to the wash column at a second temperature, and the second temperature may be lower than the first temperature. Thus, when the water stream contacts the flue gas in the wash column 12, the water stream may absorb heat from the flue gas. After the heated water stream is provided to the water stream recycle conduit 28, the heat exchanger 16 may remove heat that is absorbed by the water stream in the wash column 12. Preferably, the heat exchanger 16 cools the water stream to a temperature (e.g., the second temperature) that is lower than the first temperature of the flue gas.

The heat exchanger 16 may be in fluid communication with the mix point 18, the circulation pump 20, and/or the water stream recycle conduit 28. Thus, as illustrated the heat exchanger 16 may cool the water stream after the water stream is dosed with the thiosulfate salt reactant by the dosing mechanism 24. Alternatively, the heat exchanger 16 may not be provided in the water stream recycle conduit 28 but may otherwise be in fluid communication with the water stream that is introduced to the wash column 12.

The flow rate of the water stream provided to the wash column 12 may depend on several factors relating to the flue gas. First, the flow rate of the water stream may correspond to the rate at which the flue gas is introduced to the wash column 12. Second, the flow rate of the water stream may correspond to the temperature of the flue gas. Third, the flow rate of the water stream may correspond to the moisture content of the flue gas. Fourth, the flow rate of the water stream may depend at least partially on whether the flue gas is pretreated or preprocessed before being introduced to the wash column 12. In some embodiments, the flow rate of the water stream may not depend on any characteristic of the flue gas.

The flow rate of the water stream entering or provided to the wash column 12 may be about 1 kg/h of water per 1 kg/h of flue gas to about 10 kg/h of water per 1 kg/h flue gas. In some embodiments, the flue gas may be cooled and dehydrated before being introduced to the system 10 and/or the wash column 12. In such embodiments, the flow rate of the water stream may be about 1 kg/h of water per 1 kg/h of flue gas. In other embodiments, the flue gas may be introduced to the system 10 at a high temperature and/or with a high moisture content. In such embodiments, the flow rate of the water stream may be greater than about 1 kg/h of water per 1 kg/h of flue gas. Such flow rates of the water stream could include about 4-5 kg/h of water per 1 kg/h of flue gas or about 10 kg/h of water per 1 kg/h of flue gas. In addition, any possible variation in the flow rate of the water stream besides those listed herein is within the scope of the present system and method.

The water stream containing the thiosulfate salt reactant may be provided to the wash column 12 via the top portion 12A. In such an embodiment, the water stream containing the thiosulfate salt reactant may flow in a downward direction through the wash column 12 while the flue gas may flow in an upward direction through the wash column 12. As the water stream flows through the wash column 12, the water stream may contact the flue gas and absorb the NO₂ of the flue gas into the liquid phase (i.e., into the water stream). Once the NO₂ is absorbed into the liquid phase, the thiosulfate salt reactant may react with the NO₂, oxidizing the thiosulfate salt reactant. The oxidation reaction may produce a compound with higher water solubility than the flue gas and/or the NO₂. As the thiosulfate salt reacts with the NO₂, the NO₂ dissolved or contained within the water stream may be depleted, which in turn may allow for additional NO₂ from the flue gas to be absorbed by the water stream. After contacting the water stream, the treated flue gas may flow out of the wash column 12 via the flue gas outlet (not illustrated) coupled to the top portion 12A and the flue gas discharge line 30. After contacting the flue gas, the water stream may flow out of the wash column 12 via a water stream outlet (not illustrated) coupled to the bottom portion 12B.

If the water stream is recirculated or recycled in the system 10, the water stream from the wash column 12 may flow from the bottom portion 12B, through the water stream recycle conduit 28, and back to the top portion 12A. This recycling or recirculation of the water stream may be facilitated by the circulation pump 20. Further, as the water stream is recycled or recirculated it may optionally be dosed with additional thiosulfate salt reactant from the dosing mechanism 24 and/or be provided to the heat exchanger 16. For example, in the embodiment illustrated in FIG. 1, the mix point 18 and the heat exchanger 16 are both provided in the water stream recycle conduit 28.

Referring still to FIG. 1, the flue gas outlet of the wash column 12 may be in fluid communication with the flue gas discharge line 30. The flue gas discharge line 30 may be provided with or in communication with the analyzer 14. The analyzer 14 may be provided in the form of a device designed to measure at least one parameter of the flue gas. By way of example, the at least one parameter may include a concentration of a component of the flue gas, the residual water content of the flue gas, the temperature of the flue gas, the pressure of the flue gas, the flow rate of the flue gas, the density of the flue gas, the viscosity of the flue gas, and the like. Preferably, the analyzer 14 may be designed to measure the concentration of a component of the flue gas, such as the NO₂ concentration of the flue gas. In such embodiments, the analyzer 14 may be provided in the form of a potentiometry sensor, a moisture content sensor (hygrometry or psychrometry), a gas chromatography device, a refractive index device, an ultrasound device, a spectroscopy system (e.g., UV, visible, IR, Mossbauer, Raman, atomic-emission device, X-ray device, electron, ion, nuclear magnetic resonance), a polarography device, a conductimetry device, a mass spectrometry system, a differential thermal analysis device, a thermogravimetric analysis system, and/or combinations thereof.

In some embodiments, the analyzer 14 may be in communication with the controller 29. In such embodiments, information regarding the at least one parameter acquired by the analyzer 14 may be transferred to the controller 29. Suitable connections coupling the controller 29 to the analyzer 14 may include transmitters that allow process signals, such as electrical signals or gas pressure signals (e.g., air, nitrogen, etc.), to be transmitted between the controller 29 and the analyzer 14. In some aspects, the electrical signals may be transferred via a wired connection or through a wireless network connection. Other hardware elements may be included in the process control system, for example, transducers, analog-to-digital (A/D) converters, and digital-to-analog (D/A) converters that allow process information to be recognizable in computer form, and computer commands accessible to the process. The suitable connections described herein may also be used to couple the analyzer 14 to other components of the system 10, such as the dosing mechanism 24.

Referring still to FIG. 1, the controller 29 includes a processor 50 and a memory 52. The memory 52 includes software 54 and data 56, and is designed for storage and retrieval of processed information to be processed by the processor 50. The processor 50 includes an input 58 that is configured to receive process signals (e.g., signals from the analyzer 14) via the input 58. The controller 29 may operate autonomously or semi-autonomously, may read executable software instructions from the memory 52 or a computer-readable medium (e.g., a hard drive, a CD-ROM, flash memory), and/or may receive instructions via the input 58 from a user, or another source logically connected to a computer or device, such as another networked computer or server. For example, the server may be used to control the system 10 via the controller 29 on-site or remotely.

The processor 50 may process the process signals provided as the input 58 to generate an output 60. The output 60 may take the form of a process control action. Example process control actions may include sending signals to the dosing mechanism 24 to change the amount of thiosulfate salt reactant provided to the water stream. Other process control actions may include initiating a secondary or an additional treatment of the treated flue gas, as further described herein. Further process control actions may include, for example, adjusting one or more operational parameters of the pump 20 to increase or decrease the pressure of the recycle stream, adjusting one or more operational parameters of the heat exchanger, adjusting one or more parameters of the analyzer (e.g., type of measurement, frequency of measurement, etc), and adjusting other parameters related to the operation of the system.

In some embodiments, a secondary treatment that reduces the NO₂ content of the treated flue gas may be carried out. In such embodiments, the treated flue gas exiting the wash column 12 may be analyzed by the analyzer 14 to determine the NO₂ concentration of the flue gas. After taking the measurement, the analyzer 14, the controller 29, or a technician may determine that the treated flue gas requires further treatment to further reduce its NO₂ content. In such cases, the flue gas may be treated with a secondary or additional washing with the water stream. For example, the secondary or additional washing may be carried out in the wash column 12 or in a secondary wash column (not illustrated) that is provided as a part of or coupled to the system 10.

If the secondary or additional washing is carried out in the wash column 12, a conduit (not illustrated) may be provided such that the treated flue gas may be reintroduced to the wash column 12. For example, the treated flue gas may be mixed with the untreated flue gas via a recirculation point in the conduit 26. Alternatively, the treated flue gas may be introduced to the wash column 12 separate from the untreated flue gas via a treated flue gas inlet (not illustrated) provided in the bottom portion 12B of the wash column 12.

In some embodiments, the analyzer 14 (or the controller 29) may determine that the secondary or additional washing is necessary when the NO₂ content of the treated flue gas is at or above a threshold value. Alternatively, an additional amount of the thiosulfate salt reactant may be added to the water stream at the mix point 18 to reduce or eliminate the need for a secondary washing of the flue gas. For example, the amount of thiosulfate salt reactant provided by the dosing mechanism 24 could be increased by an amount corresponding to the concentration of unreacted NO₂ content in the treated flue gas. In addition, the analyzer 14 (and/or the controller 29) may also determine that no secondary or additional washing of the treated flue gas is necessary when the NO₂ content of the treated flue gas is at or below the threshold value.

The threshold value may be manually or automatically input into the analyzer 14 (and/or the controller 29). For example, the threshold may be input by a technician such that the treated flue gas matches the needs of any downstream processes or emission limits associated with the flue gas. Further, the threshold may be adjusted manually or automatically if the downstream operations of the plant change.

After the first, optional second, and/or additional washing of the flue gas, a treated flue gas substantially free of NO₂ may be obtained. For example, a treated flue gas may be obtained from the flue gas discharge line 30 which is substantially free of NO₂. Alternatively, a flue gas with a reduced NO₂ content (as compared to the untreated flue gas) may be obtained from the system 10 after the flue gas is processed by the system 10.

The NO₂ content of the treated flue gas may be about 0% (v/v) to about 1% (v/v) after the flue gas is processed by the system 10. For example, the NO₂ content of the treated flue gas may be no greater than about 1.5% (v/v), or no greater than about 1% (v/v), or no greater than about 0.9% (v/v), or no greater than about 0.8% (v/v), or no greater than about 0.7% (v/v), or no greater than about 0.6% (v/v), or no greater than about 0.5% (v/v), or no greater than about 0.4% (v/v), or no greater than about 0.3% (v/v), or no greater than about 0.2% (v/v), or no greater than about 0.1% (v/v), or no greater than about 0.05% (v/v), or no greater than about 0.01% (v/v), or no greater than about 0.005% (v/v), or no greater than about 0.001% (v/v), or no greater than about 0.0005% (v/v), or no greater than about 0.0001% (v/v), or no greater than about 0% (v/v).

For example, the NO₂ content of the flue gas may be reduced from about 0-2% (v/v) to about 0.0005-0.0001% (v/v) after the flue gas is processed by the system 10. As an additional example, the NO₂ content of the flue gas may be reduced from about 0.01% (v/v) to about 0.0005-0.0001% (v/v) after the flue gas is processed by the system 10.

For example, the NO₂ content of the flue gas may be reduced by about 60% to about 100% after the flue gas is processed by the system 10. As an additional example, the NO₂ content of the flue gas may be reduced by about 95% to about 99% after the flue gas is processed by the system 10.

Referring still to FIG. 1, the flue gas provided to the wash column 12 may be cooled in the wash column 12 by the water stream. The water stream may be provided to the wash column 12 at a lower temperature than the flue gas. Thus, when the flue gas contacts the water stream, the water stream may absorb heat from the flue gas, thereby reducing the temperature of the flue gas. Optionally, or preferably, the flue gas may be cooled in the wash column 12 to approximately the same temperature as the water stream. In an embodiment, the temperature of the flue gas may be reduced by about 20° C. to about 100° C. in the wash column 12. Alternatively, the temperature of the flue gas may be reduced by about 25° C. to about 80° C. in the wash column 12. For example, the temperature of the flue gas may be reduced by at least 20° C., or at least 30° C., or at least 40° C., or at least 50° C., or at least 60° C., or at least 70° C., or at least 80° C., or at least 90° C. in the wash column 12. The water stream may cool the flue gas before, during, or after the oxidation reaction between the thiosulfate salt reactant and the NO₂ in the flue gas occurs.

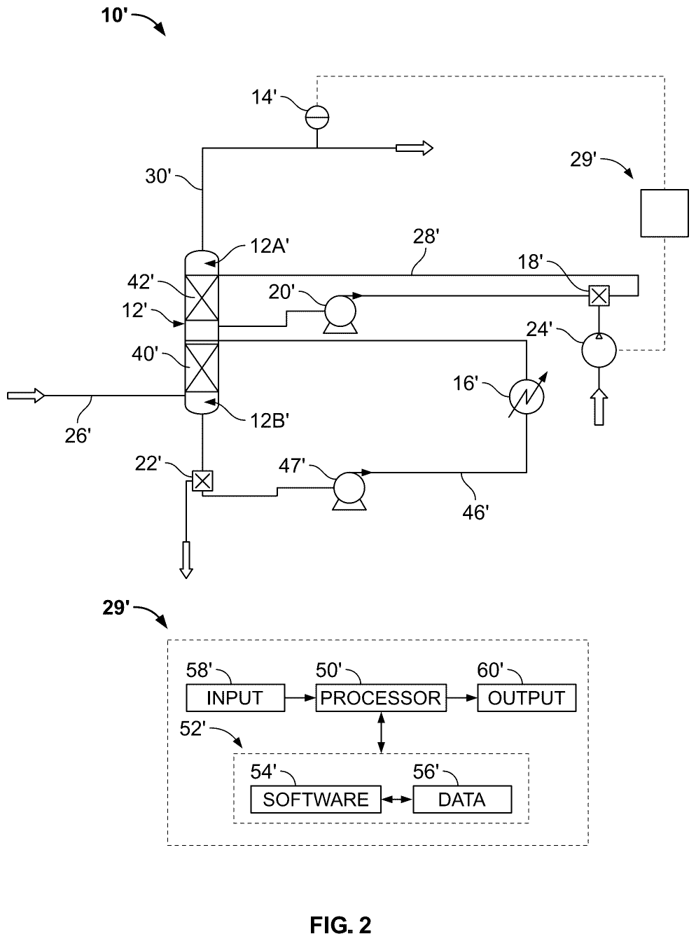

In some embodiments, a water stream that does not contain a thiosulfate salt reactant may be provided to the flue gas to cool the flue gas. In other embodiments, the wash column 12 may be coupled to or provided with a condenser that can cool the flue gas. In yet other embodiments, such as the embodiment illustrated in FIG. 2, the wash column 12 may be provided with a gas cooling section wherein the flue gas is contacted by a second water stream that is configured to cool the flue gas.

Referring again to FIG. 1, as the flue gas is cooled, water may condense out of the flue gas. The condensed water may be drained from the system 10 at the drain point 22. For example, if water is condensed from the flue gas in the wash column 12, the condensed water may flow to the bottom portion 12B of the wash column and to the drain point 22 to be drained from the system 10. A bleed member, such as a bleed hole or a bleed pipe, may be provided at the drain point 22 to facilitate the draining of the condensed water from the system 10.

The condensed water generated by cooling the flue gas may help remove a product of the oxidation reaction between the thiosulfate salt reactant and the NO₂ from the wash column 12. As the condensed water flows through the wash column 12, the condensed water may absorb at least a portion of the product. The product may then be drained from the system 10 via the drain point 22 along with the condensed water. Alternatively, if no cooling of the flue gas occurs within the wash column 12, or if an insufficient amount of condensed water is generated to remove the product, a small amount of water may be added to the wash column 12 to continuously remove the product from the wash column 12. As the additional water flows through the wash column 12, the additional water may absorb at least a portion of the product of the oxidation reaction and the product may then be removed from the system 10 via the drain point 22 along with the additional water as the additional water is drained from the system 10.

Optionally, the treated flue gas (i.e., a flue gas that is substantially free of NO₂ or has a reduced NO₂ content) may be processed to condense water therefrom. To condense the water from the treated flue gas, the treated flue gas may be contacted by a liquid (such as a second water stream) that is provided at a lower temperature than the treated flue gas. The liquid may be passed through the heat exchanger 16 to remove the heat absorbed from the flue gas by the second water stream, and the second water stream may then be recirculated. Condensed water from the treated flue gas may be drained from the system 10 (together with any oxidation reaction products) via the bleed member at the drain point 22.

The treated flue gas that exits the wash column 12 may further be treated with a CO₂-removal solvent. The CO₂-removal solvent may be provided in an apparatus that is coupled to the flue gas discharge line 30 or an apparatus that is provided outside of the system 10. Advantageously, because the NO₂ content of the treated flue gas is reduced or substantially eliminated (as compared to the untreated flue gas), the CO₂-removal solvent is protected from degradation. Thus, less solvent may be used to remove the CO₂ from the treated flue gas as compared to the untreated flue gas.

In alternative embodiments of the system 10, the thiosulfate salt reactant may be introduced to the flue gas via a wet scrubber or a direct contact cooler. In such embodiments, the thiosulfate salt reactant may selectively remove the NO₂ from the flue gas during treatment with the wet scrubber or the direct contact cooler. Thus, the NO₂ content of the flue gas may be reduced or substantially eliminated before the NO₂ contacts the CO₂-removal solvent. Advantageously, because the CO₂-removal solvent is protected from degradation, less solvent may be used in these processes. As a direct contact cooler is commonly used in CO₂-removal processes, the NO₂ removal may be achieved without adding any major equipment to the flue gas treatment system. In embodiments utilizing a wet scrubber or a direct contact cooler, the thiosulfate salt reactant may be added to (by way of example): a water stream recycling loop that is in fluid communication with the direct contact cooler; a wet scrubber (with no liquid recirculation); a liquid provided to a liquid scrubber, wherein the flue gas is bubbled through a liquid containing the reactant; and/or a liquid provided to a spray tower, wherein the liquid is sprayed into an open tower. In such embodiments, like the embodiments including the wash column 12, the thiosulfate salt reactant may selectively remove the NO₂ from the flue gas before the flue gas is further processed or vented.

Referring now to FIG. 2, a system 10′ for reducing the NO₂ content of a flue gas is illustrated. Similarly numbered or similarly named components of the system 10′ may have substantially the same function and configuration as the similarly named components described with reference to FIG. 1. The system 10′ may be provided in the form of a wash column 12′, an analyzer 14′, a heat exchanger 16′, a mix point 18′, a first circulation pump 47′, a second circulation pump 20′, a discharge (or drain) point 22′, a dosing mechanism 24′, and a controller 29′.

In comparison to the wash column 12 of the system 10, the wash column 12′ of the system 10′ may be provided in the form of a vessel with a gas cooling section 40′ and a reaction section 42′ in addition to the top portion 12A′ and the bottom portion 12B′. The gas cooling section 40′ may be designed to condense water from the flue gas, and the reaction section 42′ may be designed to remove the NO₂ from the flue gas. Further, the sections 40′, 42′ of the wash column 12′ may be provided with separate water streams, i.e., a first water stream and a second water stream, respectively. Generally, the first water stream may be utilized to cool the flue gas provided to the wash column 12′ and the second water stream may contain the thiosulfate salt reactant configured to remove NO₂ from the flue gas.

The first water stream and the second water stream may be recirculated through or recycled in the system 10′ via a first water stream recycle conduit 46′ and a second water stream recycle conduit 28′. Thus, the gas cooling section 40′ may be placed in fluid communication with the first circulation pump 47′ and the heat exchanger 16′ via the first water stream recycle conduit 46′. In comparison, the reaction section 42′ may be placed in fluid communication with the second circulation pump 20′, the dosing mechanism 24′, and optionally a heat exchanger via the second water stream recycle conduit 28′.

Referring still to FIG. 2, the reaction section 42′ may be provided adjacent to or within the top portion 12A′, and the gas cooling section 40′ may be provided adjacent to or within the bottom portion 12B′. In other embodiments, the gas cooling section 40′ may be provided proximate to or within the top portion 12A′, and the reaction section 42′ may be provided proximate to or within the bottom portion 12B′.

As the flue gas travels through the wash column 12′, the flue gas may pass through the gas cooling section 40′. The gas cooling section 40′ may be designed to lower the temperature of the flue gas by contacting the flue gas with the first water stream. For example, the flue gas may be provided to the gas cooling section 40′ at a first temperature, the first water stream may be provided to the gas cooling section at a second temperature, wherein the second temperature is less than the first temperature. After being cooled in the gas cooling section 40′, the temperature of the flue gas may be less than the temperature first temperature. For example, the flue gas may be cooled to about the second temperature. After cooling the flue gas, the first water steam may be at a temperature above the second temperature. The first water stream may then exit the wash column 12′ and flow through the first water stream recycle conduit 46′ and to the heat exchanger 16′, which may remove heat from the water stream. After passing through the heat exchanger 16′, the first water stream may then be returned to the wash column 12′ (and specifically to the gas cooling section 40′). Preferably, the first water stream provided to the gas cooling section 40′ is not dosed with the thiosulfate salt reactant.

As the flue gas is cooled, water may condense out of the flue gas. The condensed water may be drained from the system 10′ at the drain point 22′. For example, if water is condensed from the flue gas in the gas cooling section 40′, the condensed water may flow to the bottom portion 12B′ of the wash column and to the drain point 22′ to be drained from the system 10′. A bleed member, such as a bleed hole or a bleed pipe, may be provided at the drain point 22 to facilitate the draining of the condensed water from the system 10′.

The condensed water may help remove a product of the oxidation reaction between the thiosulfate salt reactant and the NO₂ from the wash column 12′. As the condensed water flows through the wash column 12′, the condensed water may absorb at least a portion of the product and the product may then be drained from the system 10′ via the drain point 22′ along with the condensed water. Alternatively, if no cooling of the flue gas occurs within the wash column 12′ (e.g., if the gas cooling section 40′ is not provided), or if an insufficient amount of condensed water is generated to remove the product, a small amount of water may be added to the wash column 12′ to continuously remove the product from the wash column 12′. As the additional water flows through the wash column 12′, the additional water may absorb at least a portion of the product of the oxidation reaction. The product may then be removed from the system 10′ via the drain point 22′ along with the additional water as the additional water is drained from the system 10′.

Referring still to FIG. 2, the flue gas may enter the bottom portion 12B′ of the wash column 12′ and flow upwardly through the wash column 12′ and to the gas cooling section 40′. Alternatively, the flue gas may be provided directly to the gas cooling section 40′ and flow upwardly through the gas cooling section 40′.

Once the temperature of the flue gas is lowered in the gas cooling section 40′, the flue gas may continue flowing upwardly through the wash column 12′. The flue gas may then enter, be received, or otherwise provided to the reaction section 42′ of the wash column 12′. The reaction section 42′ may be disposed above the gas cooling section 40′ and within the same vessel as the gas cooling section 40′, or the reaction section 42′ may be provided in a separate wash column. The flue gas may be treated with a thiosulfate salt reactant within the reaction section 42′. The thiosulfate salt reactant may be introduced to the flue gas in substantially the same manner as those described herein with reference to the wash column 12.

The reaction section 42′ may be in fluid communication with the second water stream recycle conduit 28′, the second circulation pump 20′, and the mix point 18′. In accordance with the teachings provided herein, the thiosulfate salt reactant may be introduced to the second water stream at the mix point 18′ via the dosing mechanism 24′. After being dosed with the thiosulfate salt reactant, the second water stream may be introduced to the top portion 12A′ of the wash column 12′. For example, the second water stream may be provided above the reaction section 42′, or the second water stream may be provided directly to the reaction section 42′. After the second water stream is introduced to the wash column 12′, the second water stream may travel downwardly through the wash column 12′. Preferably, the second water stream is collected before entering the gas cooling section 40′ and is thereby provided to the second water stream recycle conduit 28′. Advantageously, because water is condensed from the flue gas before the flue gas is provided to the reaction section 42′, the concentration of the thiosulfate salt reactant in the second water stream may not be diluted by the condensed water. This configuration may help the wash column 12′ more efficiently remove NO₂ from the flue gas as the flue gas is processed in the reaction section 42′.

As described above with reference to FIG. 1, the thiosulfate salt reactant of FIG. 2 may comprise at least one of a sodium thiosulfate (Na₂S₂O₃) salt reactant, a potassium thiosulfate (K₂S₂O₃) salt reactant, a magnesium thiosulfate (MgS₂O₃) salt reactant, a calcium thiosulfate (CaS₂O₃) salt reactant, an ammonium thiosulfate ((NH₄)₂S₂O₃) salt reactant, and/or mixtures thereof.

After the flue gas containing NO₂ is treated with the water stream containing the thiosulfate salt reactant, a treated flue gas substantially free from NO₂ or a treated flue gas with reduced NO₂ content may be obtained. After a treatment within the wash column 12′, the flue gas may exit the wash column 12′ via the top portion 12A′ and be provided to the flue gas discharge line 30′.

An additional or optional secondary removal of NO₂ from the treated flue gas may be performed. The treated flue gas may be analyzed using the analyzer 14′ to determine if the secondary or additional treatment is necessary to further reduce the NO₂ of the treated flue gas. In some embodiments, as explained above in FIG. 1, the analyzer 14′ (and/or the controller 29′) may determine that further processing of the treated flue gas is necessary when the NO₂ content in the treated flue gas is at or above a threshold value. Furthermore, the analyzer 14′ (and/or the controller 29′) may determine that no further treatment of the flue gas is necessary when the NO₂ content of the treated flue gas is at or below a threshold value. The threshold value can be manually or automatically input into the analyzer 14′ (and/or the controller 29′) by a technician to match the needs of any downstream processes or emission limits associated with the flue gas.

In some embodiments, after the NO₂ content of the flue gas is measured by the analyzer 14′, additional thiosulfate salt reactant may be introduced to the second water stream at the mix point 18′ by the dosing mechanism 24′. Adding additional thiosulfate salt reactant to the second water stream may reduce or eliminate the need for the secondary or additional processing of the treated flue gas.

After the secondary or additional reduction of NO₂ content in the treated flue gas, a flue gas substantially free from NO₂ may be obtained. Alternatively, a flue gas with a reduced NO₂ content may be obtained.

The NO₂ content of the treated flue gas may be about 0% (v/v) to about 1% (v/v) after the flue gas is processed by the system 10′. For example, the NO₂ content of the treated flue gas may be no greater than about 1.5% (v/v), or no greater than about 1% (v/v), or no greater than about 0.9% (v/v), or no greater than about 0.8% (v/v), or no greater than about 0.7% (v/v), or no greater than about 0.6% (v/v), or no greater than about 0.5% (v/v), or no greater than about 0.4% (v/v), or no greater than about 0.3% (v/v), or no greater than about 0.2% (v/v), or no greater than about 0.1% (v/v), or no greater than about 0.05% (v/v), or no greater than about 0.01% (v/v), or no greater than about 0.005% (v/v), or no greater than about 0.001% (v/v), or no greater than about 0.0005% (v/v), or no greater than about 0.0001% (v/v), or no greater than about 0% (v/v).

For example, the NO₂ content of the flue gas may be reduced from about 0-2% (v/v) to about 0.0005-0.0001% (v/v) after the flue gas is processed by the system 10′. As an additional example, the NO₂ content of the flue gas may be reduced from about 0.01% (v/v) to about 0.0005-0.0001% (v/v) after the flue gas is processed by the system 10′.

For example, the NO₂ content of the flue gas may be reduced by about 60% to about 100% after the flue gas is processed by the system 10′. As an additional example, the NO₂ content of the flue gas may be reduced by about 95% to about 99% after the flue gas is processed by the system 10′.

Methods of reducing or substantially eliminating NO₂ content of a flue gas are provided. These methods may utilize any of the components of the systems 10, 10′ as described herein. Further, as would be appreciated by those having skill in the art, the methods may utilize additional or fewer components than those provided with the systems 10, 10′.

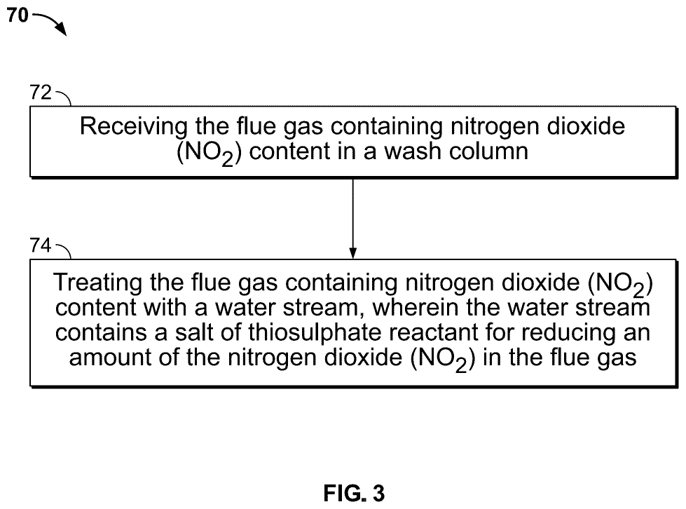

Turning to FIG. 3, a method 70 for reducing nitrogen dioxide (NO₂) content in a flue gas is provided. Generally, the method comprises receiving the flue gas containing nitrogen dioxide (NO₂) in a wash column and treating the flue gas containing nitrogen dioxide (NO₂) with a water stream, wherein the water stream contains a thiosulfate salt reactant for reducing the content of the NO₂ in the flue gas.

The method 70 may begin either manually or automatically. The method includes a step 72 wherein the flue gas containing NO₂ is received in a wash column. In some embodiments, the flue gas may be provided to a bottom portion of the wash column. In some embodiments, the wash column provided in the step 72 is the wash column 12 or the wash column 12′ described in connection with FIGS. 1 and 2.

The method 70 may further include a step 74, wherein the flue gas containing NO₂ content is treated with a water stream. Preferably, the water stream contains a thiosulfate salt reactant for reducing the nitrogen dioxide (NO₂) content of the flue gas. In some embodiments, the thiosulfate salt reactant comprises at least one of a sodium thiosulfate (Na₂S₂O₃) salt reactant, a potassium thiosulfate (K₂S₂O₃) salt reactant, a magnesium thiosulfate (MgS₂O₃) salt reactant, a calcium thiosulfate (CaS₂O₃) salt reactant, an ammonium thiosulfate ((NH₄)₂S₂O₃) salt reactant, and/or mixtures thereof. In some embodiments, the thiosulfate salt reactant is provided to the water stream via a dosing mechanism that is in fluid communication with the water stream.

The method 70 may contain additional steps as desired by a plant operator and as described herein. For example, an additional or secondary reduction of NO₂ content of the flue gas may be provided. As an additional example, the water stream may be recirculated via a water stream recycle loop that is in fluid communication with the wash column.

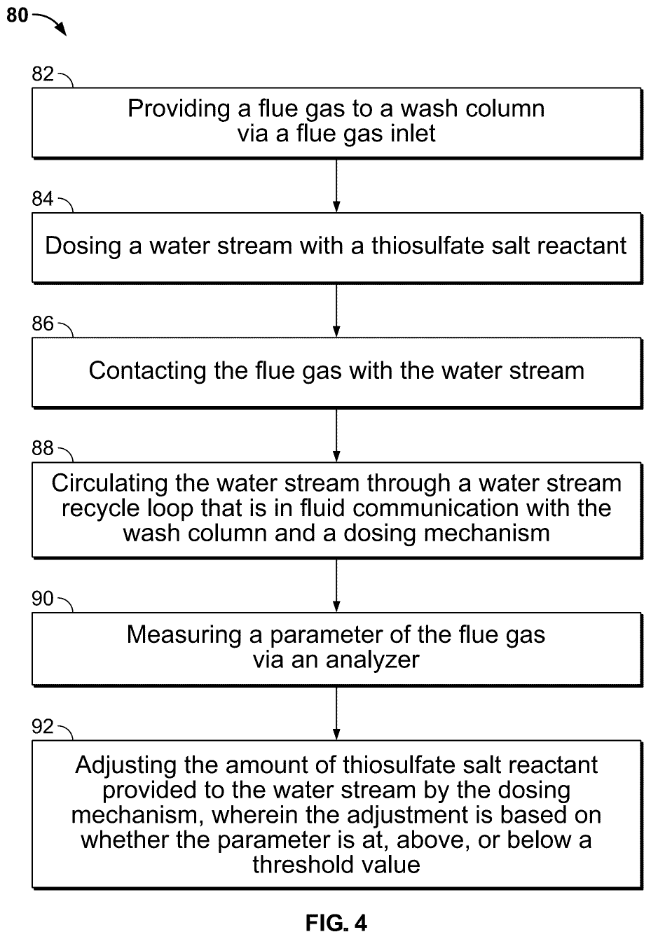

Referring now to FIG. 4, another method 80 for reducing the nitrogen dioxide (NO₂) content of a flue gas is provided. The method 80 may comprise a step 82 of providing a flue gas to a wash column via a flue gas inlet, a step 84 of dosing a water stream with a thiosulfate salt reactant, and a step 86 of contacting the flue gas with the water stream. Optionally, the method 80 may include a step 88 of circulating the water stream through a water stream recycle loop that is in fluid communication with the wash column and a dosing mechanism. Optionally, the method 80 may include a step 90 of measuring a parameter of the flue gas via an analyzer. Optionally, the method may include a step 92 of adjusting the amount of thiosulfate salt reactant provided to the water stream by the dosing mechanism, wherein the adjustment is based on whether the parameter is at, above, or below a threshold value.

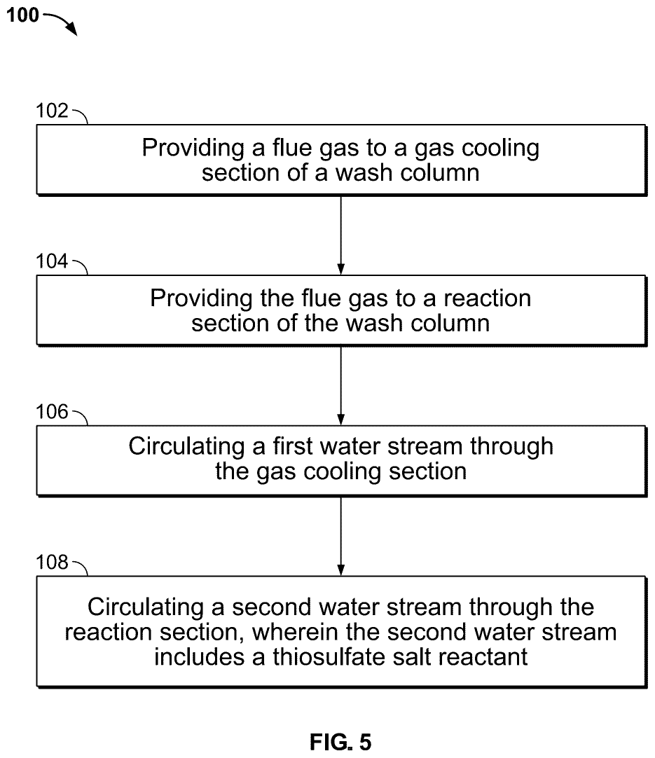

Referring now to FIG. 5, yet another method 100 for reducing the nitrogen dioxide (NO₂) content of a flue gas is provided. The method 100 may comprise a step 102 of providing a flue gas to a gas cooling section of a wash column, a step 104 of providing the flue gas to a reaction section of the wash column, a step 106 of circulating a first water stream through the gas cooling section, and a step 108 of circulating a second water stream through the reaction section, wherein the second water stream includes a thiosulfate salt reactant.

Optionally, the method 100 may include a step of recirculating the first water stream via a first water stream recycle conduit. Optionally, the method 100 may include a step of recirculating the second water stream via a second water stream recycle conduit. Optionally, the method 100 may include a step of a measuring a parameter of the flue gas via an analyzer and a step of adjusting the amount of thiosulfate salt reactant provided to the water stream by the dosing mechanism based on whether the parameter is at, above, or below a threshold value.

The methods recited herein may provide a treated flue gas that is substantially free from NO₂. Alternatively, methods recited herein may provide a treated flue gas with a reduced NO₂ content, as compared to the untreated flue gas.

The NO₂ content of the treated flue gas generated by the methods herein may be about 0% (v/v) to about 1% (v/v). For example, the NO₂ content of the treated flue gas generated by the methods herein may be no greater than about 1.5% (v/v), or no greater than about 1% (v/v), or no greater than about 0.9% (v/v), or no greater than about 0.8% (v/v), or no greater than about 0.7% (v/v), or no greater than about 0.6% (v/v), or no greater than about 0.5% (v/v), or no greater than about 0.4% (v/v), or no greater than about 0.3% (v/v), or no greater than about 0.2% (v/v), or no greater than about 0.1% (v/v), or no greater than about 0.05% (v/v), or no greater than about 0.01% (v/v), or no greater than about 0.005% (v/v), or no greater than about 0.001% (v/v), or no greater than about 0.0005% (v/v), or no greater than about 0.0001% (v/v), or no greater than about 0% (v/v).

In some embodiments, the methods provided herein may include various additional and/or optional steps including a step of condensing water from the flue gas stream. In some embodiments, the methods provided herein may include a step of draining a condensed water from the system via a bleed mechanism. In some embodiments, the methods provided herein may include a step of removing heat from a water stream via a heat exchanger. In some embodiments, the methods provided herein may include a step of providing a secondary or additional washing of the flue gas. In some embodiments, a recirculation pump and/or a heat exchanger may be provided in a water stream recycling loop.

The present systems and methods provided herein may remove NO₂ from a flue gas at a lower temperature and with less expensive equipment than other systems and methods. The present systems and methods provided herein may use a reactant (e.g., a thiosulfate salt reactant) that may react with the NO₂ at ambient temperatures. In addition, the present systems and methods also remove NO₂ from the flue gas to help prevent solvent degradation in a later CO₂ removal process.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. Various features and advantages of the disclosure are set forth in the following claims.

1. A system for reducing nitrogen dioxide (NO₂) content of a flue gas, the system comprising:
a wash column designed to:
receive the flue gas containing the nitrogen dioxide (NO₂); and
treat the flue gas with a first water stream, the first water stream including a thiosulfate salt reactant.

2. The system of claim 1, wherein the flue gas is provided to the wash column at a first temperature, the first water stream is provided to the wash column at a second temperature, and wherein the first temperature is greater than the second temperature.

3. The system of claim 2, wherein the first water stream is in fluid communication with a heat exchanger designed to remove heat absorbed by the first water stream from the flue gas.

4. The system of claim 1, wherein the wash column further includes a top portion and a bottom portion, and wherein the top portion and the bottom portion are in fluid communication with a water stream recycling conduit.

5. The system of claim 1, the system further including a dosing mechanism in communication with a controller, wherein the dosing mechanism is designed to provide the thiosulfate salt reactant to the first water stream, and wherein the controller is designed to control an amount of the thiosulfate salt reactant provided to the first water stream by the dosing mechanism.

6. The system of claim 1, wherein the wash column further includes a gas cooling section and a reaction section, and wherein the gas cooling section is positioned adjacent to a bottom section of the wash column and the reaction section is positioned adjacent to a top section of the wash column.

7. The system of claim 6, wherein the first water stream is provided to the reaction section, and wherein a second water stream is provided to the gas cooling section.

8. An apparatus for reducing nitrogen dioxide content of a flue gas, the apparatus comprising:
a wash column in fluid communication with a water stream, the wash column having an inlet via which the flue gas is provided to the wash column from a source; and
a dosing mechanism designed to provide a thiosulfate salt reactant to the water stream, wherein the thiosulfate salt reactant reacts with the flue gas to remove the nitrogen dioxide therefrom.

9. The apparatus of claim 8, wherein the wash column is defined by a top portion and a bottom portion, and the inlet for the flue gas is coupled to the bottom portion of the wash column and the water stream is provided to the top portion of the wash column.

10. The apparatus of claim 8, wherein the apparatus further includes a water stream recycle conduit in fluid communication with the wash column, and the water stream is provided to the wash column via the water stream recycle conduit.

11. The apparatus of claim 8, wherein the apparatus further includes a water stream recycle conduit in fluid communication with the wash column, and the dosing mechanism is coupled to the water stream recycle conduit.

12. The apparatus of claim 8, wherein the apparatus further includes a flue gas discharge line coupled to the wash column, and the flue gas discharge line is in fluid communication with an analyzer designed to measure at least one parameter of the flue gas.

13. The apparatus of claim 12, wherein a first parameter of the at least one parameter is a nitrogen dioxide concentration of the flue gas, and the analyzer measures a value of the first parameter, and wherein an amount of thiosulfate salt reactant provided to the water stream by the dosing mechanism is adjusted based on the value of the first parameter.

14. The apparatus of claim 8, wherein the apparatus further including a controller that is designed to change an amount of thiosulfate salt reactant provided to the water stream by the dosing mechanism based on a measurement of at least one parameter of the flue gas by an analyzer.

15. A method of reducing nitrogen dioxide content of a flue gas, the method comprising:
providing the flue gas to a wash column;
dosing a water stream with a thiosulfate salt reactant; and
contacting the flue gas with the water stream.

16. The method of claim 15 further including a step of circulating the water stream through a water stream recycle conduit, wherein the water stream recycle conduit is in fluid communication with the wash column and a dosing mechanism.

17. The method of claim 15 further including a step of measuring a parameter of the flue gas via an analyzer.

18. The method of claim 15 further including steps of:
measuring a nitrogen dioxide concentration of the flue gas using an analyzer; and
adjusting an amount of thiosulfate salt reactant provided to the water stream when the nitrogen dioxide concentration of the flue gas is at or above a threshold value.

19. The method of claim 15 further including steps of:
cooling the flue gas to condense water therefrom; and
providing condensed water to a bleed member.

20. The method of claim 15, wherein the thiosulfate salt reactant comprises at least one of a sodium thiosulfate (Na₂S₂O₃) salt reactant, a potassium thiosulfate (K₂S₂O₃) salt reactant, a magnesium thiosulfate (MgS₂O₃) salt reactant, a calcium thiosulfate (CaS₂O₃) salt reactant, or an ammonium thiosulfate ((NH₄)₂S₂O₃) salt reactant.
